(19) United States
(12) Patent Application Publication
(10) Pub. No.: US 2003/0110338 A1
(43) Pub. Date: Jun. 12, 2003

(54) Method and apparatus for emulating computer buses using point-to-point techniues

(76) Inventors: Yuanlong Wang, San Jose, CA (US); Kewei Yang, San Jose, CA (US)

Correspondence Address: Jake J'maev, 12616 Lewis Ave, Chino, CA, 91710, US

(21) Appl. No.: 10/010,132

(22) Filed: Dec. 6, 2001

(51) Int. Cl. G06F 13/14

(52) U.S. Cl. 710/305

(57) ABSTRACT

Method and apparatus for receiving bus signals from a first computer module, converting those bus signals into a first point-to-point link and directing the first point-to-point link to a bus emulator. The bus emulator propagates data transfer cycles arriving by the first point-to-point link to a second point-to-point link. The second point-to-point link carries data transfer cycles to a second computer module. The second point-to-point link is converted back into bus signals that interface with the second computer module.

### FIELD OF THE INVENTION

This invention relates generally to computer bus architectures.

### BACKGROUND OF THE INVENTION

Traditionally, computer buses have comprised a plurality of bus signals generally used to interconnect various computer modules forming a computer system. Computer buses are generally segregated into a plurality of functional sections. A computer bus may comprise a data section. A computer bus may further comprise an address section. Generally, a computer bus may also further comprise a data transfer indicator section. A computer bus may also further comprise an arbitration section.

Despite the actual functional implementation of any particular computer bus, traditional computer buses are typically structured in a common-connection manner. The common-connection may be embodied as a collection of circuit traces disposed on a printed circuit board. Connectors may be disposed on the printed circuit board so as to allow individual computer modules to connect to the common-connection traces. In some computer bus structures, the data section, the address section, and the data transfer indicator section will all be embodied in such a common-connection manner. In most computer bus structures, the arbitration section stands alone by providing unique signals for each module in a computer system. These unique signals are normally used to carry bus requests from each computer module to a central arbiter. The central arbiter recognizes individual requests from the computer modules and issues unique bus-grant signals indicating that a particular computer bus module has been granted access to the common-connection data, address and data transfer indicator sections.

Scalability and operational speed for such traditional bus structures may be limited by the physics associated with the printed circuit traces, the connectors attached thereto, and other capacitive and inductive effects introduced by the computer modules themselves. The physical effects of the printed circuit traces can limit the length, i.e. the span of a bus. The effective load each computer module exhibits may limit the number of computer modules that can be attached to any particular bus because of capacitive slowing of and inductive ringing in the digital signals carried by the bus. Together, these two factors may limit the expansion of computer systems based on traditional bus structures.

### SUMMARY OF THE INVENTION

In one example embodiment of a method according to the present invention, communications between computer modules may be provided by first converting native bus signals, used by a computer module to interface to a computer bus, into a point-to-point link. The native computer bus signals may be converted either into a serial link or into a parallel link. Depending on any particular embodiment, the present invention further comprises high-current, high-speed drivers that propagate the point-to-point link to a bus emulator.

The point-to-point link operates by monitoring the activity of the computer module's native bus interface. When a data transfer cycle is recognized, the data field, the address field and the nature of the data transfer are all captured and propagated by the point-to-point link to the bus emulator. In those example embodiments that comprise a serial point-to-point link, a parallel-to-serial converter is used to serialize the data sent to the bus emulator.

The example method described here provides that the data transfer cycle, as represented by the native bus signals and converted into the point-to-point link, are received in the bus emulator and propagated by a second point-to-point link to a second computer module. Prior to reaching the second computer module, the second point-to-point link is converted back into the native format used by the second computer module.

According to this illustrative method, propagating the converted signal through the bus emulator comprises the steps of translating the point-to-point link into a bus structure internal to the bus emulator. The converted bus signals are then conveyed to a second converter that drives a second point-to-point interface.

In some alternative embodiments of the present invention, the converted bus signals arriving at the bus emulator cannot be propagated to the internal bus structure until that bus structure becomes available. This alternative method provides for arbitration amongst simultaneous data transfer cycles arriving at the bus emulator by way of a plurality of point-to-point interfaces.

The present invention may also comprise an embodiment of a computer system based on the method described above. Accordingly, one example embodiment of such a computer system comprises a plurality of point-to-point interface units. Each point-to-point interface unit comprises a computer module interface and a point-to-point interface. The computer module interface allows a single computer module to be connected to the point-to-point interface unit using the native form of that computer module's interface bus. In some alternative embodiments, the point-to-point interface may be made integral to a computer module. In some other example embodiments, the computer module may implement the protocol of a point-to-point interface directly; eliminating the need for any translation circuitry.

In some example embodiments of the present invention, the point-to-point interface unit may further comprise a parallel-to-serial converter that accepts bus transfer signals from the computer module interface and develops a serial stream representative of the data transfer cycle. Each of these data transfer cycles may comprise an address field, a data field and an indicator depicting the type of transfer requested by the computer module.

In yet another illustrative embodiment of the present invention, the point-to-point interface unit may further comprise a high-speed parallel driver. The parallel driver may be used to propagate the address, data and cycle information received from the computer module's interface.

A computer system according to one example embodiment of the present invention further comprises a bus emulator. In some embodiments, the bus emulator may further comprise a plurality of point-to-point interfaces interconnected by an internal bus structure. In some embodiments of the present invention, the bus emulator may further comprise an arbiter that grants access to the internal bus to one of a plurality of point-to-point interfaces when simultaneous bus requests are pending.

The present invention provides for an alternative embodiment of the bus emulator wherein the bus emulator may further comprise a cascade port that allows the length of the bus emulator's internal bus to be extended.

The present invention further comprises a computer module that comprises a point-to-point interface. In some illustrative embodiments, the point-to-point interface comprising the computer module comprises a parallel-to-serial converter that serializes the address, data and cycle information. In other example embodiments, the point-to-point interface may comprise a high-speed parallel driver that propagates the address, data and cycle information to a bus emulator.

The present invention further comprises a bus emulator that supports the method of the present invention. In one example embodiment of the present invention, the bus emulator comprises a plurality of point-to-point interfaces interconnected by an internal bus. In some alternative embodiments, the bus emulator may further comprise an arbiter that grants access to the internal bus to the point-to-point interfaces when more than one interface requests access to the bus. In yet another illustrative embodiment, the bus emulator may further comprise a cascade port that allows the internal bus of the emulator to be extended.

### BRIEF DESCRIPTION OF THE DRAWINGS

The foregoing aspects are better understood from the following detailed description of one embodiment of the invention with reference to the drawings, in which:

FIG. 1 is a block diagram that depicts a traditional bus structure as used in computer systems;

FIG. 2 is a block diagram that depicts a computer system according to one example embodiment of the present invention; and

FIG. 3 is a block diagram of the internal structure of a bus emulator according to one illustrative embodiment of the present invention.

### DETAILED DESCRIPTION OF THE INVENTION

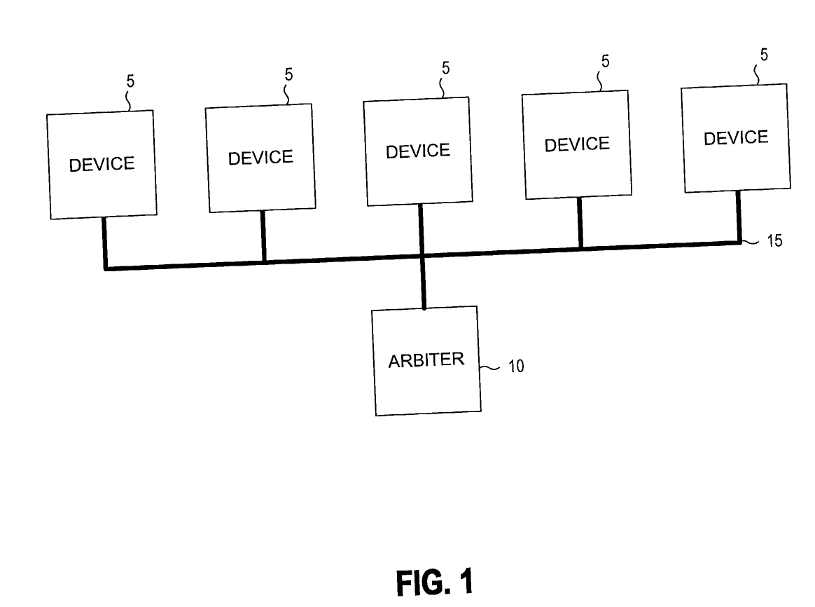

FIG. 1 is a block diagram that depicts a traditional bus structure as used in computer systems. According to this figure, a plurality of bus-oriented devices 5 are connected to a computer bus 15. In many past embodiments, the computer bus comprised a plurality of parallel bus signals grouped into functional blocks. These functional blocks may include, but are not necessarily limited to address and data fields and a data transfer indicator field.

In most bus structures used in computer systems, the plurality of computer bus oriented devices, which can also be referred to as computer “modules”, all contend for the same bus resource. In order to apportion this bus resource amongst the various computer modules, an arbiter 10 is normally affiliated with the computer bus structure. The arbiter may comprise a specialized module attached to the bus or it may be incorporated onto one of the other computer modules that use the bus for data transfer. In either type of arbiter implementation, the arbiter 10 receives bus requests from each computer module. The arbiter 10 will use some predetermined method for granting the bus resource to one of the plurality of computer modules whenever those modules have activated their bus request signal. Because two simultaneous bus requests cannot be accommodated at the same time, only one computer module in a computer system will be granted access to the bus. Other computer modules may need to wait until the bus resource becomes available, and based upon their access priority, they will receive a bus grant in due course of system operation.

The bus structure is etched as a common-connection bus onto a circuit board. In this type of structure, as already noted herein, the speed of bus operation will degrade with each additional computer module attached to the bus. This is due primarily to the physical reality of capacitive and inductive loading of digital devices attached to the bus. Additional degradation occurs as a result of the physical length of the traces and the propagation delays induced by impedance mismatches that result through circuit board fabrication. All of these factors collectively limit the number of computer modules that can be attached to the same bus structure.

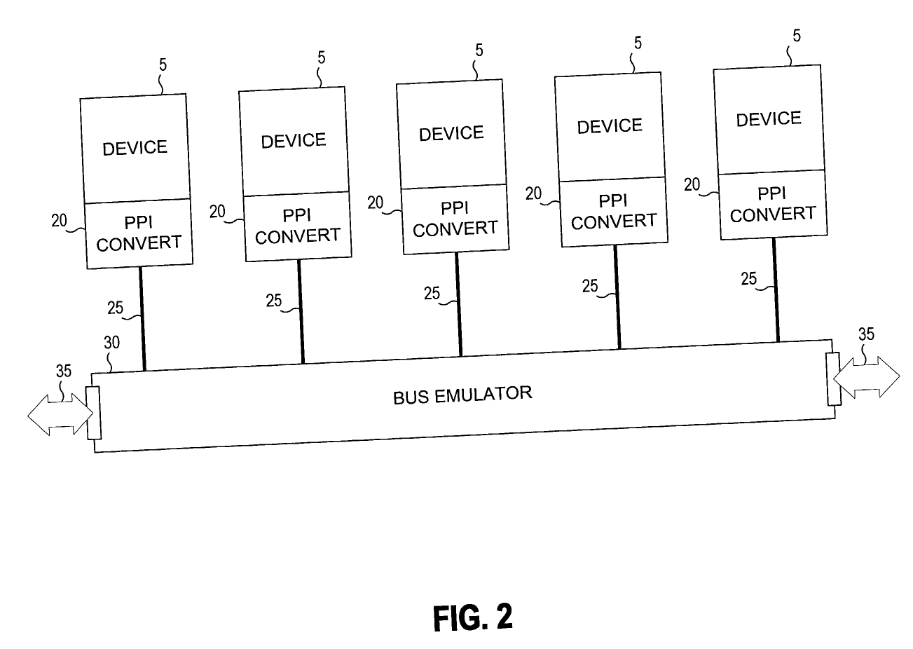

FIG. 2 is a block diagram that depicts a computer system according to one example embodiment of the present invention. In contrast to the traditional bus-oriented structure used in most computer systems, this example embodiment comprises computer modules 5 that are connected to a plurality of point-to-point conversion units 20. Each point-to-point conversion unit 20 accepts the native bus structure used by a computer module 5 and converts that signal structure into a ubiquitous point-to-point interface. In many embodiments, the actual structure of the point-to-point interface mimics the native bus structure used by the computer module 5. In yet other embodiments, a truly ubiquitous bus structure is used so that computer modules having varying native bus structure can be incorporated into the same computer system. In these types of embodiments, different types of point-to-point interface units are provided so that varying native bus structures can all be translated into the ubiquitous point-to-point link.

In this illustrative embodiment, the point-to-point link is connected to a bus emulator 30. The bus emulator 30 comprises a plurality of point-to-point interfaces each of which can accept a single point-to-point link 25 driven by a point-to-point conversion unit 20.

The bus emulator 20 may further comprise one or more cascade ports 35. The purpose of such cascade ports 35 is to enable connection of one bus emulator 30 to another. This allows the total fan-out of a computer system built according to the present invention to be expanded.

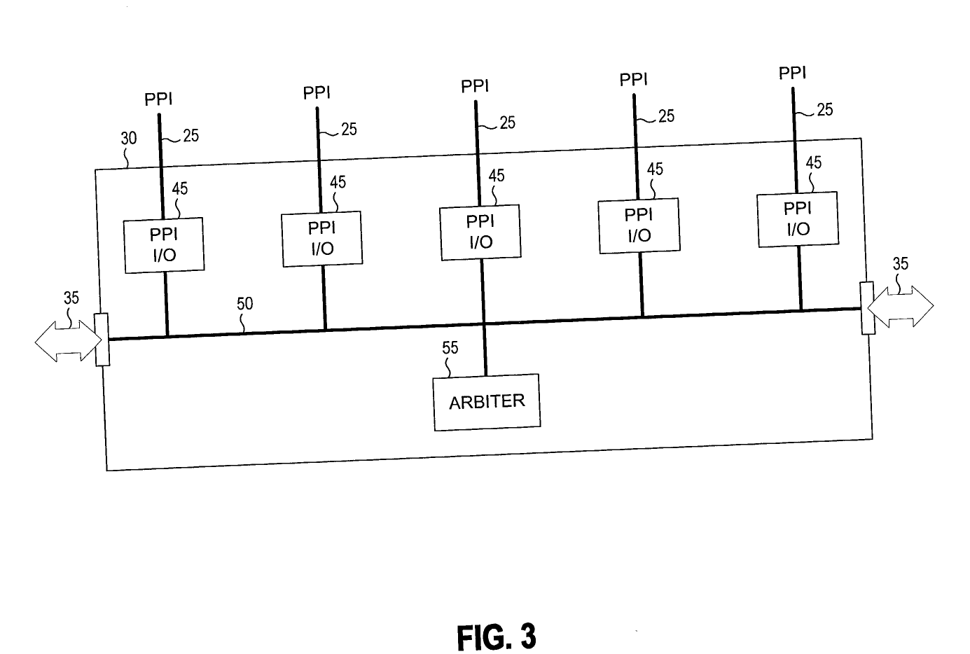

FIG. 3 is a block diagram of the internal structure of a bus emulator according to one illustrative embodiment of the present invention. In this typical embodiment, the bus emulator 30 comprises a plurality of point-to-point interfaces 45 each connected to an internal bus structure 50. The internal bus structure 50 may comprise some ubiquitous bus structure or it may comprise some bus structure compatible with the native bus used by a particular type of computer module.

According to this example embodiment, the bus emulator may further comprise an arbiter 55. The arbiter receives independent requests for access to the internal bus structure 50 from each point-to-point interface 45 comprising the bus emulator. The arbiter 55 applies an arbitration scheme to select one of the point-to-point interfaces 45 from the plurality as the current grantee of the internal bus structure 50. The arbiter 55 issues an independent bus grant to the prevailing point-to-point interface 45. Once the bus grant is received by a first point-to-point interface 45, that point-to-point interface 45 may direct a data transfer cycle from a first point-to-point link 25 to the internal bus structure 50. The data transfer cycle is then propagated by the internal bus structure 50 to a second point-to-point interface 45. The second point-to-point interface 45 converts the data transfer cycle from the internal bus structure 50 to the point-to-point link 25.

In some example embodiments, the bus emulator may further comprise one or more cascade ports 35. Each cascade port 35 is connected to the internal bus structure 50. The signals carried by the internal bus structure 50 are conveyed by the cascade port 35 to some external device. The external device may be a second bus emulator comprising its own cascade port. By connecting two or more bus emulators using the cascade ports, the overall span of a computer bus system can be expanded. The cascade port 35 also carries corroboration signals from the arbiter 55. Corroboration signals enable two or more arbiters located in multiple bus emulators to cooperate in arbitration of an expanded internal bus structure 50.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for communicating between computer bus modules comprising the steps of:
converting native bus signals from a first computer module to a first point-to-point interface;
conveying the bus signals using the first point-to-point interface to a bus emulator;
conveying the bus signals from the bus emulator using a second point-to-point interface to a second computer module; and
converting the bus signals received at the second computer to a native form.

2. The method of claim 1 wherein the step of converting native bus signals from a first computer module to a first point-to-point interface comprises the steps of:
monitoring the native bus signals in order to identify the beginning of a data transfer cycle; and
accepting data and address signals from the native bus and serializing these together with an indication of the type of transfer identified.

3. The method of claim 1 wherein the step of conveying bus signals from the bus emulator to a second computer module comprises the steps of:
receiving the bus signals from the first point-to-point interface in the bus emulator;
translating the first point-to-point interface received in the bus emulator to a bus structure internal to the bus emulator;
conveying the bus signals received in the bus emulator by way of the first point-to-point interface onto said bus structure; and
translating the bus signals carried on said bus structure to a second point-to-point interface.

4. The method of claim 3 wherein the step of conveying the bus signals received in the bus emulator by way of the first point-to-point interface onto said bus structure comprises the steps of:
granting said bus structure to the first point-to-point interface if said bus structure is available; and
propagating the bus signals translated from the first point-to-point interface onto the bus structure if the bus structure is granted to said first point-to-point interface.

5. A computer system comprising:
plurality of point-to-point interface units comprising a computer module interface and a point-to-point interface;
plurality of computer modules connected to the computer module interface of the plurality of point-to-point interface units; and
bus emulator connected to the point-to-point interface of the plurality of point-to-point interface units.

6. The computer system of claim 5 wherein the plurality of point-to-point interface units comprise parallel-to-serial conversion units that operate upon detecting the beginning of a data transfer cycle presented to the computer module interface and wherein the parallel-to-serial conversion units accept a data field and an address field and a cycle-type indicator from the computer module interface.

7. The computer system of claim 5 wherein the plurality of point-to-point interface units comprise high-current parallel drivers capable of propagating data, address and data transfer cycle requests.

8. The computer system of claim 5 wherein the bus emulator comprises:
plurality of point-to-point interfaces interconnected by an internal bus.

9. The computer system of claim 8 further comprising an arbiter for granting access to the internal bus to one of the plurality of point-to-point interfaces.

10. The computer system of claim 8 further comprising a cascade port that connects to the internal bus and can be used to extend the length of the internal bus.

11. A computer module comprising a point-to-point interface.

12. The computer module of claim 11 wherein the point-to-point interface comprises:
parallel-to-serial conversion unit that operate upon detecting the beginning of a data transfer cycle presented to the computer module interface and wherein the parallel-to-serial conversion units accept a data field and an address field and a cycle-type indicator from the computer module interface and delivers a serial output comprising a data transfer cycle to the point-to-point interface.

13. The computer module of claim 11 wherein the point-to-point interface comprises high-current parallel drivers capable of propagating data, address and data transfer cycle requests.

14. A point-to-point interface unit comprising a computer module interface and a point-to-point interface.

15. The point-to-point interface unit of claim 14 further comprising parallel-to-serial conversion unit that operate upon detecting the beginning of a data transfer cycle presented to the computer module interface and wherein the parallel-to-serial conversion units accept a data field and an address field and a cycle-type indicator from the computer module interface and delivers a serial output comprising a data transfer cycle to the point-to-point interface.

16. The computer system of claim 14 wherein the plurality of point-to-point interface units comprise high-current parallel drivers capable of propagating data, address and data transfer cycle requests.

17. A bus emulator comprising:
internal bus; and
plurality of point-to-point interfaces interconnected by the internal bus.

18. The bus emulator of claim 17 an arbiter for granting access to the internal bus to one of the plurality of point-to-point interfaces.

19. The bus emulator of claim 17 further comprising a cascade port connected to the internal bus and can be used to extend the length of the internal bus.
